(19) United States
(12) Patent Application Publication
(10) Pub. No.: US 2009/0070578 A1
(43) Pub. Date: Mar. 12, 2009

(54) Methods And Systems For Transmitting Secure Application Input Via A Portable Device

(76) Inventor: David B. Lection, Raleigh, NC (US)

Correspondence Address: SCENERA RESEARCH, LLC, 111 CORNING RD., SUITE 220, CARY, NC, 27518, US

(21) Appl. No.: 11/853,450

(22) Filed: Sep. 11, 2007

(51) Int. Cl. H04L 9/00; G06F 13/00

(52) U.S. Cl. 713/155; 710/304

(57) ABSTRACT

Methods and systems are described for transmitting secure application input via a portable device. In one embodiment, a method includes connecting a portable device to a communication bus of a computing device for exchanging information between the portable device and the computing device. The method further includes connecting the portable device to an input device for exchanging information between the portable device and the input device. The method still further includes transmitting input received from the input device connected to the portable device to the communication bus of the computing device. The input is directed to an application both associated with the portable device and instantiated into a runtime environment of the computing device. The application is further associated with an input component configured for allowing the application to only receive input transmitted via the portable device when the application is instantiated into the runtime environment of the computing device.

### BACKGROUND

Many portable storage devices having various amounts of storage capacity exist today. For example, today's memory keys have an increasing amount of storage capacity available, such as the large capacity Universal Serial Bus (USB) memory keys currently available. Today's large capacity USB memory keys include USB memory keys that have applications installed on the memory key. The applications run on the memory key itself in a memory key operating environment. These memory key operating environments provide a somewhat secure way of using browser, email, and other applications on a public personal computer (PC). For example, a user could use a web browser installed on a memory key, allowing all of the artifacts generated during their browser session (cookies, cache, etc) to be stored on the memory key.

Since the memory key is still using the services of the keyboard, mouse, and network of the host computer, it is still possible to monitor the user's interactions when the user is running applications on the memory key. For example, a device can be attached in the keyboard's connection to the PC for recording all keystrokes entered on the keyboard. Similar devices and software techniques can be applied to any communications line in or out of the PC.

Accordingly, there exists a need for methods, systems, and computer program products for providing secure application input via a portable device.

### SUMMARY

Methods and systems are described for transmitting secure application input via a portable device. In one embodiment, a method for transmitting secure application input via a portable device is disclosed. The method includes connecting a portable device to a communication bus of a computing device for exchanging information between the portable device and the computing device. The method further includes connecting the portable device to an input device for exchanging information between the portable device and the input device. The method still further includes transmitting input received from the input device connected to the portable device to the communication bus of the computing device. The input is directed to an application both associated with the portable device and instantiated into a runtime environment of the computing device. The application is further associated with an input component configured for allowing the application to only receive input transmitted via the portable device when the application is instantiated into the runtime environment of the computing device.

In another embodiment, a system for transmitting secure application input via a portable device is disclosed. The system includes a first connector component configured for connecting a portable device to a communication bus of a computing device for exchanging information between the portable device and the computing device. The system also includes a second connector component configured for connecting the portable device to an input device for exchanging information between the portable device and the input device. The system further includes a memory component configured for storing at least one of an input component and an application including the input component. The application is for instantiation into a runtime environment of the computing device. The application is both associated with the portable device and the input component. The input component is configured for allowing the application to only receive input transmitted via the portable device when the application is instantiated into the runtime environment of the computing device. The system still further includes a device control processor component configured for transmitting input received from the input device connected to the portable device to the communication bus of the computing device.

In another embodiment, a method for providing secure application input via a portable device is disclosed. The method includes receiving input directed to an application instantiated into a runtime environment of a computing device. The application is associated with a portable device connectable to an input device for receiving the input directed to the application. The portable device is also connectable to a communication bus of the computing device for exchanging information, including the input directed to the application, between the portable device and the computing device. The method also includes determining whether the received input is transmitted via the portable device. The method further includes providing only the input transmitted via the portable device to the application instantiated into a runtime environment according to the determination.

In another embodiment, a system for providing secure input to an application via a portable device is disclosed. The system includes an input receiver component configured for receiving input directed to an application instantiated into a runtime environment of a computing device. The application is associated with a portable device connectable to an input device for receiving the input directed to the application. The portable device is also connectable to a communication bus of the computing device for exchanging information, including the input directed to the application, between the portable device and the computing device. The system also includes an input component configured for determining whether the received input is transmitted via the portable device. The input component is also configured for providing only the input transmitted via the portable device to the application instantiated into a runtime environment according to the determination.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for transmitting secure application input via a portable device according to an embodiment of the subject matter described herein;

FIG. 2 is a block diagram illustrating a system for transmitting secure application input via a portable device according to another embodiment of the subject matter described herein;

FIG. 3 is a block diagram illustrating a system for transmitting secure application input via a portable device according to another embodiment of the subject matter described herein;

FIG. 4 is a flow diagram illustrating a method for providing secure input to an application via a portable device according to another embodiment of the subject matter described herein;

FIG. 5 is a block diagram illustrating a system for providing secure input to an application via a portable device according to another embodiment of the subject matter described herein; and

FIG. 6 is a block diagram illustrating a system for providing secure input to an application via a portable device according to another exemplary embodiment of the subject matter described herein.

### DETAILED DESCRIPTION

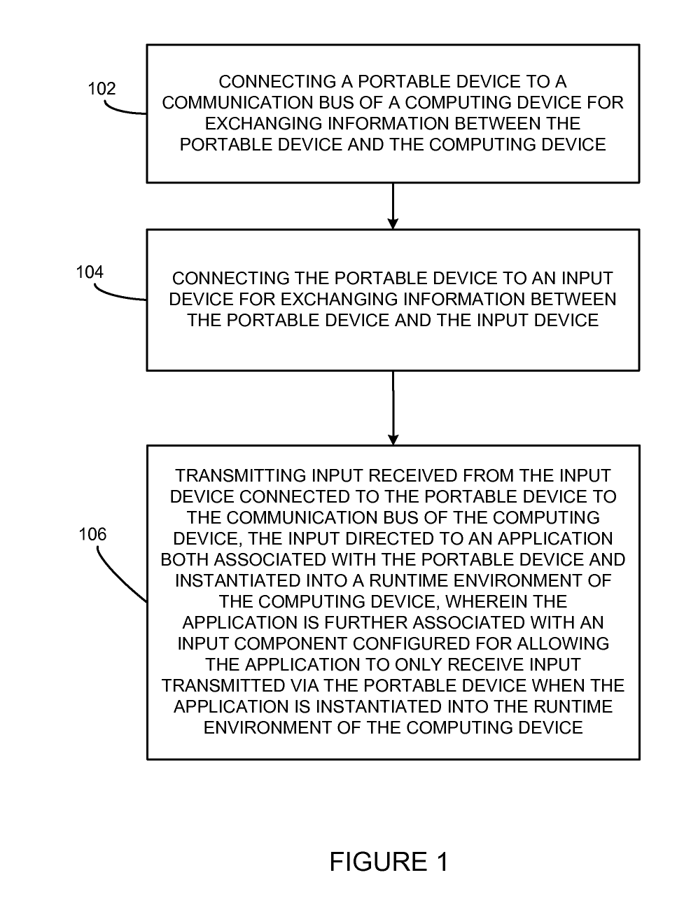

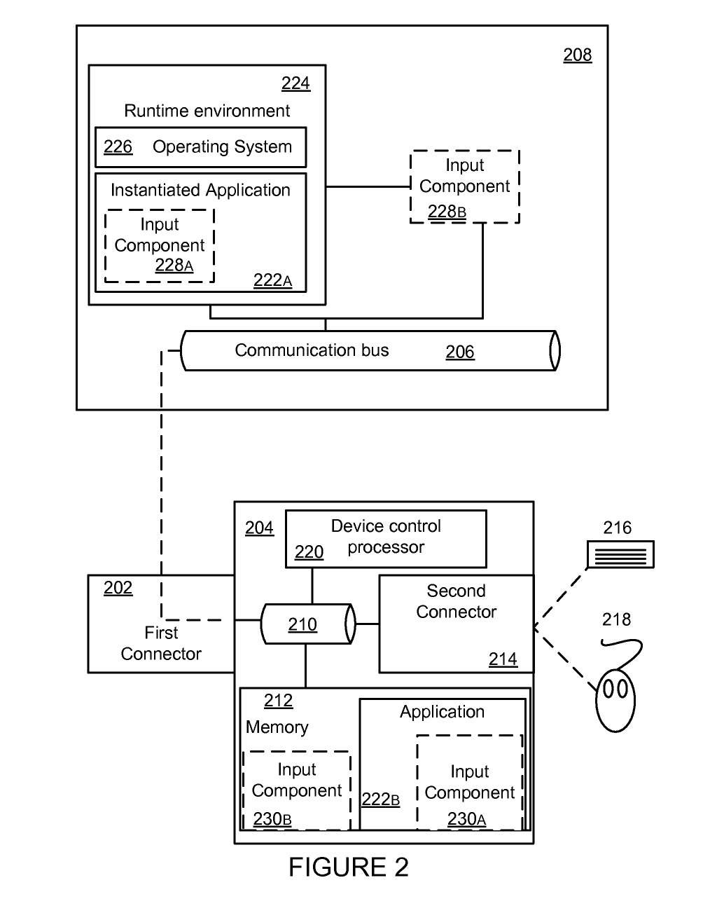

FIG. 1 is a flow diagram illustrating a method for transmitting secure application input via a portable device according to an exemplary embodiment of the subject matter described herein. FIG. 2 is a block diagram illustrating a system for transmitting secure application input via a portable device according to another exemplary embodiment of the subject matter described herein. The method illustrated in FIG. 1 can be carried out by, for example, some or all of the components illustrated in the exemplary system of FIG. 2.

With reference to FIG. 1, in block 102 a portable device is connected to a communication bus of a computing device for exchanging information between the portable device and the computing device. Accordingly, a system for transmitting secure application input via a portable device includes means for connecting a portable device to a communication bus of a computing device for exchanging information between the portable device and the computing device. For example, as illustrated in FIG. 2, a first connector component 202 is configured for connecting a portable device 204 to a communication bus 206 of a computing device 208 for exchanging information between the portable device 204 and the computing device 208.

The connection of the portable device 204 and the computing device 208 is a coupling of the communication paths of the two devices. As illustrated in FIG. 2, the dashed line between the communication bus 206 of a computing device 208 and the communication path 210 of the portable device 204 illustrates the coupling of the communication paths in the respective devices. Accordingly, information can be exchanged between the portable device 204 and the computing device 208.

In order to couple the communication paths, the portable device 204 can be physically connected to the computing device 208. For example, the first connector component 202 of the portable device 204 can be inserted into an available port of the computing device 208. According to an aspect, the portable device 204 can be a USB application device. In such an aspect, the communication bus 206 of the computing device 208 that the portable device 204 connects to can be a USB bus. For example, a first connector component 202 can be a male USB connector component in the portable device 204. In the case of a USB portable device, the portable device 204 can be connected to the host computing device 208 via the USB bus 206 of the computing device 208. In another aspect, connecting a portable device 204 to a communication bus of a computing device 208 includes wirelessly connecting the portable device 204 to a wireless adapter of the computing device. For example, the first connector component 202 can include a wireless transceiver (not shown) configured for wirelessly connecting the portable device 204 to a wireless adapter of the computing device.

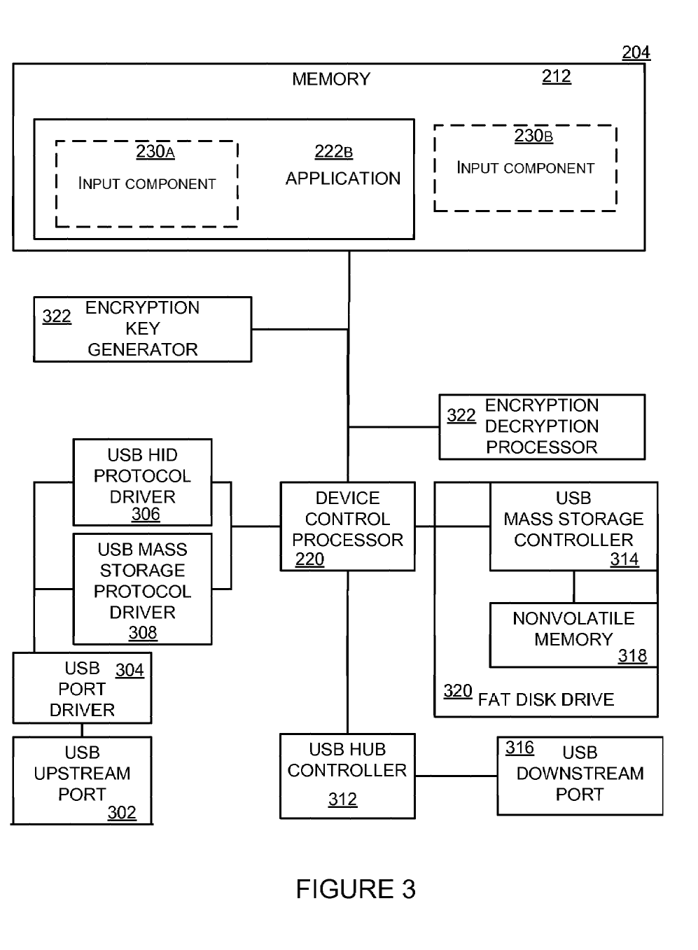

FIG. 3 further details various components of the portable device 204. The first connector component 202 connects to a USB upstream port 302. The USB upstream port 302 can be managed by a USB software stack that can include a USB port driver component 304, a USB human interface device class (HID) protocol driver 308, and a USB Mass storage protocol driver component 306. The USB software stack can be connected to the device control processor component 220. The device control processor component 220 can be a Central Processing Unit (CPU) class device that processes USB commands and USB pipe data streams received from any of the USB upstream port component 302, the USB hub controller component 312, and the USB mass storage controller component 314.

When the portable device 204 is connected to the computing device 208 using the computing device's USB communication path 206, power is available to the portable device 204, and a device initialization process begins. The USB Specification Version 2.0 specifies that electrical power of five volts is available to a USB device when connected to a USB bus. The amount of electrical current available is variable and dependent on the kinds of devices connected to the upstream USB bus. At minimum, one hundred milliamps is available, and typically five hundred milliamps is available, allowing for a single USB port to power several connected USB devices. Once attached, the portable device 204 is now in the USB Attached State for initialization. The initialization can include a startup of the device control processor component 220. Once the device control processor component 220 is initialized, it can register the portable device 204 to the computing device 208 via the USB bus component 206.

The standard USB initialization process can begin with the USB bus component 206 sensing attachment of the portable device 204. The USB bus component 206 can send a USB reset command to the USB upstream port component 302. The device control processor component 220 can signal a hub reset to the USB upstream port component 302. The portable device 204 is now in a USB Default state. The computing device 208 sends an address ID to the portable device 204. The device control processor component 220 can store the address in a memory 212 included on the portable device 204. The portable device 204 can now enter the USB Configured state.

The upstream port connection from the USB hub controller component 312 can be connected to an I/O port of the device control processor component 220. The device control processor component 220 can be a CPU processor that controls all functions of the portable device 204. These functions can include processing of USB commands and data to and from USB peripherals connected to the downstream ports of the device, encrypting and decrypting data to and from these devices that is sent upstream to applications executing locally on the computing device 208, and managing the initialization of the portable device 204 to the computing device 208.

Returning to FIG. 1, in block 104 the portable device 204 is connected to an input device for exchanging information between the portable device 204 and the input device. Accordingly, a system for transmitting secure application input via a portable device 204 includes means for connecting the portable device 204 to an input device for exchanging information between the portable device 204 and the input device. For example, as illustrated in FIG. 2, a second connector component 214 is configured for connecting the portable device 204 to an input device, a keyboard 216, for exchanging information between the portable device 204 and the input device 216.

The portable device 204 can support the connection of a variety of USB devices. For example, the portable device 204 supports connection of input devices included in the human interface device class including keyboards, mice, and other USB human interface devices. For example, FIG. 2 illustrates two input devices: a keyboard 216 and a mouse 218 capable of connecting to the portable device 204 via the second connector 214. Other devices within these device classes can be supported if they emit and process the same USB commands and data as the input devices described above.

Referring to FIG. 3, the portable device 204, according to an aspect, can include a USB downstream port component 316 for managing the second connector component 214. The USB downstream port component 316 can be connected to the USB hub controller component 312. The USB hub controller component 312 can be a specialized integrated circuit that supports connection of one or more downstream USB devices. As such, the USB hub controller component 312 can multiplex multiple USB device transactions and data streams from the downstream devices to be delivered upstream through a single USB port to a USB bus and processor. As USB input devices are connected to the USB downstream port 316, the standard USB defined sequence of processes can begin to power, identify, and assign an address to the device. Once the input device is connected to the system, the system can begin using the services of the device.

As an input device connected to the USB downstream port 316 generates input for the instantiated application 222A executing on the computing device 208, a USB data packet from the device is presented to the USB downstream port 316. The data packet is sent to the USB Hub controller component 312. The USB Hub controller component 312 forwards the data packet to the device control processor component 220. The data packet is then forwarded to the first connector component 202 via the USB software stack including the USB HID, the protocol driver component 320, and the USB port driver component 304.

Returning to FIG. 1, in block 106 input received from the input device connected to the portable device is transmitted to the communication bus of the computing device. The received input is directed to an application both associated with the portable device and instantiated into a runtime environment of the computing device. The application is further associated with an input component configured for allowing the application to only receive input transmitted via the portable device when the application is instantiated into the runtime environment of the computing device. Accordingly, a system for transmitting secure application input via a portable device 204 includes means for transmitting input received from the input device 216 connected to the portable device 204 to the communication bus 206 of the computing device 208.

For example, as illustrated in FIG. 2, a device control processor component 220 is configured for transmitting input directed to the application to the communication bus 206 of the computing device 208. The input is received from the input device 216 connected to the portable device 204. As described above in the USB downstream port 316 and a USB hub controller 312 process input received from the input device 216. The device control processor 224 transmits the received input to the USB upstream port 302 for transmitting the received input to the communication bus 206 of the computing device 208.

Once the input has been received on the communication bus 206, the input is provided to the instantiated application 222 and the runtime environment 224. The runtime environment 224 can include an operating system 226, such as the WINDOWS® operating system, the LINUX® operating system, the UNIX® operating system, or any other operating system. A WINDOWS operating environment operation is described below for exemplary purposes. Other operating systems can be used in providing secure input to an application.

The memory component 212 is configured for storing at least one of an input component 230A and an application 222B including the input component 230A. The input component 230A only allows input transmitted via the portable device 204 to reach the instantiated application. The operation of the input component 230A is described more fully below. Specifically, the operation of the input component 230A as either part of the instantiated application or as a stand-alone component is described below.

Referring to FIG. 3, the portable device 204 can include a nonvolatile memory component 318 that can be managed as a file allocation table (FAT) disk drive 320 by the USB Mass storage controller component 314. Once, the portable device 204 is connected to the computing device 208, the computing device 208 registers the FAT disk drive 320 to the local operating system. The operating system, in response, assigns the drive an identifying letter. As discussed above, at least one of the input component and the application including the input component is loadable into the computing device from the portable device 204.

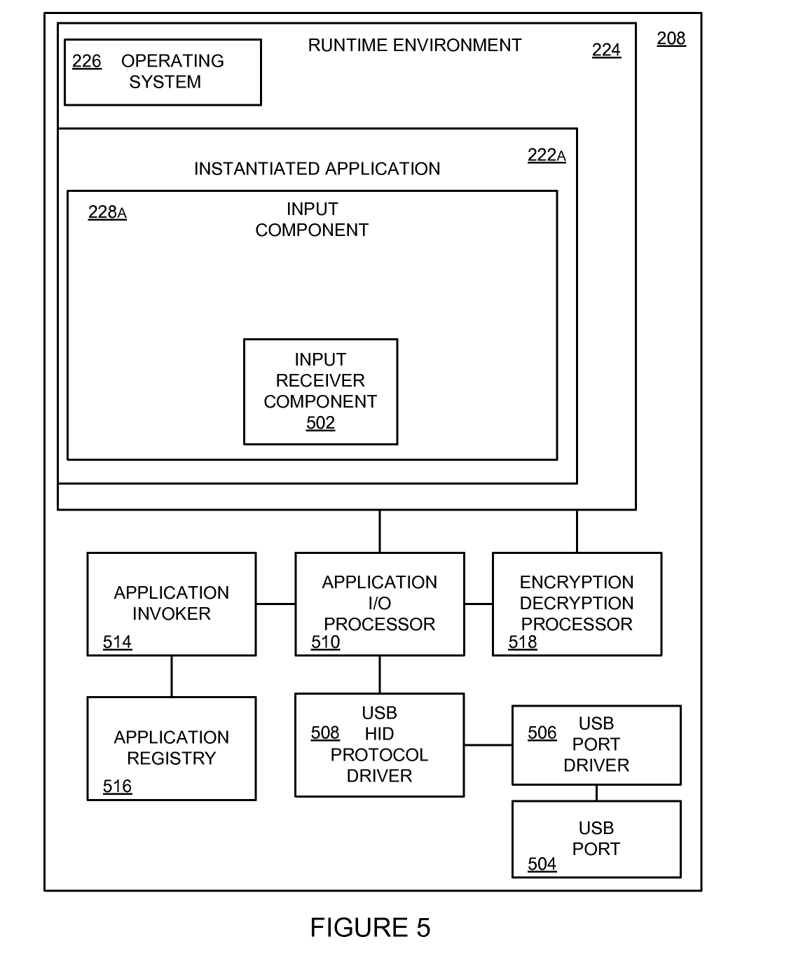

Prior to using an application associated with the portable device 204, the input component can be installed in the computing device 208 to process the input provided by the portable device 204. In a system using the MICROSOFT WINDOWS operating system, the input component can include a device driver. The device driver can be installed by invoking an installer application stored on the FAT drive of the portable device 204. When this installer is invoked, the device driver can be loaded into the computing device 208 and begin execution. The input component is detailed in FIG. 5 and discussed more fully below.

According to an aspect, the received input can be encrypted based on an encryption key included in the portable device 204. If the received input is encrypted, then the encrypted input is transmitted to the computing device 208. For example, an encryption processor 322 can be configured for encrypting the received input based on an encryption key included in the portable device 204. The encryption key included in the portable device 204 can be obtained in a variety of ways. For example, the encryption key can be preloaded on the portable application device. Alternatively, as part of the initialization of the device, an encryption key generator component 324 can be called to generate a random encryption/decryption key. Once the key is generated, the encryption processor 322 can store the encryption key.

If the input is to be encrypted, the device control processor component 220 can call the encryption processor 322 to retrieve the encryption key included in the portable device 204. The device control processor component 220 can return the encryption key in response to the request. The encryption processor 322 then encrypts the received input using the encryption key. The device control processor component 220 can be configured for transmitting the encrypted input to the communication bus 206 of the computing device 208.

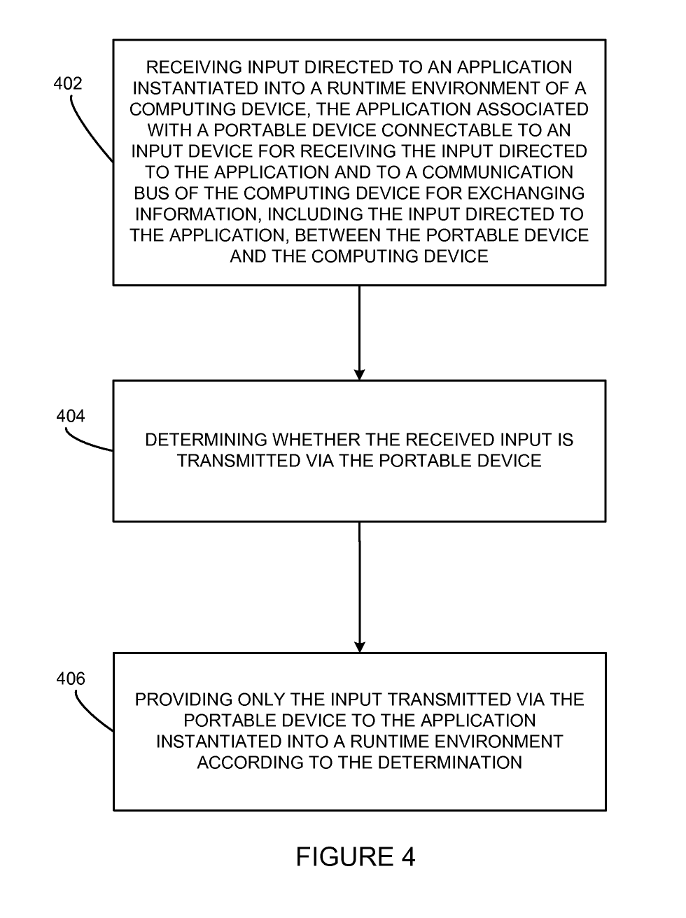

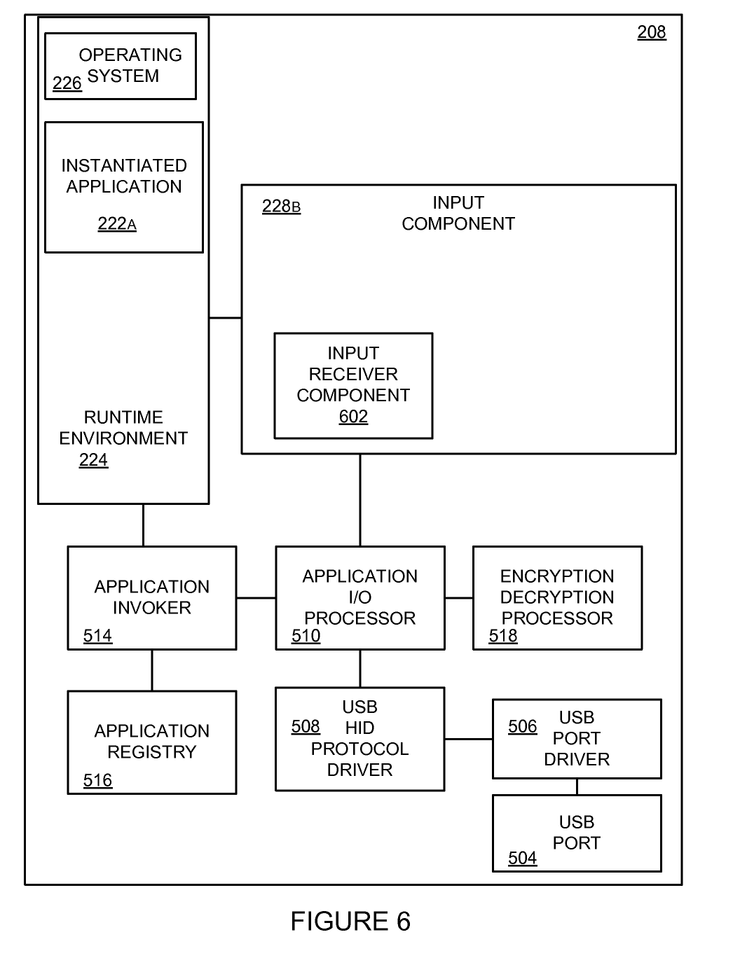

FIG. 4 is a flow diagram illustrating a method for providing secure input to an application via a portable device according to an exemplary embodiment of the subject matter described herein. FIG. 5 is a block diagram illustrating a system for providing secure input to an application via a portable device according to another exemplary embodiment of the subject matter described herein. FIG. 6 is a block diagram illustrating an alternative embodiment of a system for providing secure input to an application via a portable device according to another exemplary embodiment of the subject matter described herein. The method illustrated in FIG. 4 can be carried out by, for example, some or all of the components illustrated in the exemplary embodiments of FIG. 5 and FIG. 6.

With reference to FIG. 4, in block 402 input directed to an application instantiated into a runtime environment of a computing device is received. The application is associated with the portable device that is connectable to an input device, such as keyboard, for receiving the input directed to the application. The portable device is also connectable to a communication bus of the computing device for exchanging information, including the input directed to the application, between the portable device and the computing device. Accordingly, a system for providing secure input to an application via a portable device includes means for receiving input directed to an application instantiated into a runtime environment of a computing device.

For example, as illustrated in FIG. 5, an input receiver component 502 is configured for receiving input directed to an application 222A instantiated into a runtime environment 224 of a computing device 208. The application is associated with the portable device 204 that is connectable to an input device for receiving the input directed to the application. The portable device 204 is also connectable to a communication bus 206 of the computing device 208 for exchanging information, including the input directed to the application, between the portable device 204 and the computing device 208. In an alternative embodiment illustrated in FIG. 6, the input receiver component 602 is included in an input component 228B external to the instantiated application 222A.

The input receiver component 502 and the input receiver component 602 operate in a similar fashion. For ease of explanation, only the input receiver component 502 will be described below, as the input receiver component 602 operates in a similar fashion. The input receiver component 502 registers a WINDOWS GetMessage hook with the WINDOWS operating system using a WINDOWS SetMessageHook( ) API call. The input receiver component 502 also executes a USB data read request via the USB bus component 206 to the portable device 204. The computing device 208 can receive input from the portable device 204 using a USB port component 504, a USB port driver component 506, and a USB HID protocol driver 508. In the application, an I/O processor component 510 receives the input. The input receiver component 502 captures application input from the application I/O processor component 510 via the GetMessage hook.

Returning to FIG. 4, in block 404 it is determined whether the received input is transmitted via the portable device. Accordingly, a system for providing secure input to an application via a portable device includes means for determining whether the received input is transmitted via the portable device. For example, as illustrated in FIG. 5, an input component 228A is configured for determining whether the received input is transmitted via the portable device 204. In an alternative embodiment illustrated in FIG. 6, the input component 228B is external to the instantiated application 222A. As above, only the input component 228A will be described as the input component 228B operates in a substantially similar manner as the input component 228A.

The GetMessage hook described above allows the input component 228A to view all messages destined for an application, before they are presented to the application for processing. The GetMessage hook can alter the contents of a message or reject a message entirely. In the MICROSOFT WINDOWS operating system, all keyboard and mouse input events are processed by the application's GetMessage process. To operate the GetMessage hook, the application 222A must be invoked. The application 222A can be invoked by calling the application invoker component 514. This component uses a CreateProcess( ) WINDOWS API call to load the application from the portable device 204. Once the application is loaded into the computing device 208 and initialized, the application invoker component 514 calls the WINDOWS GetCurrentProcessId( ) API call, which returns the process ID of the application 222A.

The application invoker component 514 calls the application registry component 516 to store the process ID for use by the GetMessage hook.

When the instantiated application 222A calls the WINDOWS GetMessage( ) API to retrieve the next keyboard or mouse event message, the GetMessage hook is called by the operating system. The GetMessage hook retrieves the process ID of the calling application and determines if the process ID is in the application registry component 516. If the process ID is in the application registry component 516, then the contents of the message containing the keyboard or mouse event are checked to determine if encryption is in use. If the event message is encrypted, then the GetMessage hook calls the encryption/decryption component 518 to decrypt the content in the WINDOWS message destined for the application. The content of the event message is then forwarded to the application. The message includes information identifying the source of the input. Accordingly, the input component 228A can determine whether the received input is transmitted via the portable device 204.

Returning to FIG. 4, in block 406 only the input transmitted via the portable device is provided to the application instantiated into a runtime environment according to the determination. Accordingly, a system for providing secure input to an application via a portable device includes means for providing only the input transmitted via the portable device to the application instantiated into a runtime environment according to the determination.

For example, as illustrated in FIG. 5, the input component 228A is configured for providing only the input transmitted via the portable device 204 to the application instantiated into a runtime environment according to the determination. In an alternative embodiment illustrated in FIG. 6, the input component 228B is external to the instantiated application that 222A. As above, only the input component 228A will be described as the input component 228B operates in a substantially similar manner as the input component 228A.

In another aspect, the input component 228A can be configured for discarding input directed to the instantiated application based on the determination that the input is not transmitted via the portable device 204. The input handler component 520 discards any input from the standard WINDOWS subsystem. This prohibits the application 222A from retrieving input from devices not connected via the portable device 204. Since input from devices not connected through the device 204 that is presented via the standard WINDOWS input subsystem is discarded, and application 222A reads data only from the portable device 204, any software hooks or hardware input monitors, and the like, connected to input devices that are not connected to the portable device 204 will not have access to input data from the portable device 204.

In another aspect, the input component 228A can be configured for providing a notification indicating the input is not transmitted via the portable device 204. For example, the GetMessage hook can also be called when input from a non-secure input device connected to the computing device 208 generates an input event (mouse or keyboard) for the application. The GetMessage hook detects this input and blocks it from being presented to the application 222A. The GetMessage hook can call an operating system service to provide a notification indicating that the input is not accepted. Alternatively, the input handler component 502 can be configured for providing a notification, such as a tone or visual notification, indicating the input is not transmitted via the portable device 204.

When the portable device 204 is disconnected from the host computing device 208, the operating system and associated USB support subsystems release the driver letter and other operating system resources associated with portable device 204 and any peripherals connected directly to the device via the USB port component 504. The port driver component 506 can be configured for detecting a disconnecting of the portable device 204. The application processor component 510 can be configured for terminating the instantiated application in response to the detection. If the device becomes disconnected while the application 222A continues to execute on the computing device 208, when the application makes a call for input or output, an error indicator will be returned to the application to signal the device is no longer connected. The application can terminate immediately or can prompt the user to terminate the application.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g) or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for transmitting secure application input via a portable device, the method comprising:
connecting a portable device to a communication bus of a computing device for exchanging information between the portable device and the computing device;
connecting the portable device to an input device for exchanging information between the portable device and the input device; and
transmitting input received from the input device connected to the portable device to the communication bus of the computing device, the input directed to an application both associated with the portable device and instantiated into a runtime environment of the computing device, wherein the application is further associated with an input component configured for allowing the application to only receive input transmitted via the portable device when the application is instantiated into the runtime environment of the computing device.

2. The method of claim 1 wherein the portable device is a universal serial bus (USB) application device and the communication bus of the computing device is a USB bus.

3. The method of claim 1 wherein connecting a portable device to a communication bus of a computing device includes wirelessly connecting the portable device to a wireless adapter of the computing device.

4. The method of claim 1 wherein at least one of the input component and an application including the input component is included on the portable device and is loadable into the computing device from the portable device.

5. The method of claim 1 wherein the input component is configured for determining whether input directed to the instantiated application is transmitted via the portable device.

6. The method of claim 5 wherein the input component is configured for discarding input directed to the instantiated application based on the determination that the input is not transmitted via the portable device.

7. The method of claim 5 wherein the input component is configured for providing a notification indicating the input is not transmitted via the portable device.

8. The method of claim 1 including encrypting the received input based on an encryption key included in the portable device and wherein transmitting input to the computing device includes transmitting encrypted input to the computing device.

9. A method for providing secure input to an application via a portable device, the method comprising:
receiving input directed to an application instantiated into a runtime environment of a computing device, the application associated with a portable device connectable to an input device for receiving the input directed to the application and to a communication bus of the computing device for exchanging information, including the input directed to the application, between the portable device and the computing device;
determining whether the received input is transmitted via the portable device; and
providing only the input transmitted via the portable device to the application instantiated into a runtime environment according to the determination.

10. The method of claim 9 including discarding input directed to the instantiated application based on the determination that the input is not transmitted via the portable device.

11. The method of claim 9 including providing a notification indicating the input is not transmitted via the portable device.

12. The method of claim 9 including:
detecting a disconnecting of the portable device; and
terminating the instantiated application in response to the detection.

13. A system for transmitting secure application input via a portable device, the system comprising:
a first connector component configured for connecting a portable device to a communication bus of a computing device for exchanging information between the portable device and the computing device;
a second connector component configured for connecting the portable device to an input device for exchanging information between the portable device and the input device;
a memory component configured for storing at least one of an input component and an application including the input component, the at least one of the input component and the application for instantiation into a runtime environment of the computing device, wherein the application is both associated with the portable device and the input component and the input component is configured for allowing the application to only receive input transmitted via the portable device when the application is instantiated into the runtime environment of the computing device; and
a device control processor component configured for transmitting input directed to the application, the input received from the input device connected to the portable device to the communication bus of the computing device.

14. The system of claim 13 wherein the portable device is a universal serial bus (USB) application device and the communication bus of the computing device is a USB bus.

15. The system of claim 13 wherein the first connector component includes a wireless transceiver configured for wirelessly connecting the portable device to a wireless adapter of the computing device.

16. The system of claim 13 wherein the input component is configured for determining whether input directed to the instantiated application is transmitted via the portable device.

17. The system of claim 16 wherein the input component is configured for discarding input directed to the instantiated application based on the determination that the input is not transmitted via the portable device.

18. The system of claim 16 wherein the input component is configured for providing a notification indicating the input is not transmitted via the portable device.

19. The system of claim 13 including an encryption processor component configured for encrypting the received input based on an encryption key included in the portable device and wherein the device control processor component is configured for transmitting input to the computing device includes transmitting encrypted input to the computing device.

20. A system for providing secure input to an application via a portable device, the system comprising:
an input receiver component configured for receiving input directed to an application instantiated into a runtime environment of a computing device, the application associated with a portable device connectable to an input device for receiving the input directed to the application and to a communication bus of the computing device for exchanging information, including the input directed to the application, between the portable device and the computing device; and
an input component configured for determining whether the received input is transmitted via the portable device and providing only the input transmitted via the portable device to the application instantiated into a runtime environment according to the determination.

21. The system of claim 20 wherein the input component is configured for discarding input directed to the instantiated application based on the determination that the input is not transmitted via the portable device.

22. The system of claim 20 wherein the input component is configured for providing a notification indicating the input is not transmitted via the portable device.

23. The system of claim 20 including:
a port driver component configured for detecting a disconnecting of the portable device; and
an application processor component configured for terminating the instantiated application in response to the detection.

24. A computer readable medium including a computer program, executable by a machine, for providing secure input to an application via a portable device, the computer program comprising executable instructions for:
receiving input directed to an application instantiated into a runtime environment of a computing device, the application associated with a portable device connectable to an input device for receiving the input directed to the application and to a communication bus of the computing device for exchanging information, including the input directed to the application, between the portable device and the computing device; and
determining whether the received input is transmitted via the portable device; and
providing only the input transmitted via the portable device to the application instantiated into a runtime environment according to the determination.
